(19) United States
(12) Patent Application Publication
(10) Pub. No.: US 2004/0058041 A1
(43) Pub. Date: Mar. 25, 2004

(54) Food processing apparatus, method of preserving a food product and preserved food product

(76) Inventor: Kevin S. Greenwald, Walla Walla, WA (US)

Correspondence Address: WELLS ST. JOHN P.S., 601 W. FIRST AVENUE, SUITE 1300, SPOKANE, WA, 99201, US

(21) Appl. No.: 10/256,274

(22) Filed: Sep. 25, 2002

(51) Int. Cl. A23L 1/31

(52) U.S. Cl. 426/321

(57) ABSTRACT

A method of preserving a food product, a food processing apparatus, and a preserved food product are disclosed and wherein the method includes subjecting a food product to be preserved to ultra high hydrostatic pressure in the presence of a liquid treatment; the food processing apparatus includes a conveyor assembly for moving a food product along a path of travel; a spraying assembly for dispensing a liquid treatment and which is oriented in spraying relation relative to the conveyor assembly; a packaging station positioned downstream of the conveyor; and a hydrostatic pressure application assembly positioned downstream of the packaging station; and a food product is disclosed and which has been subjected to ultra high hydrostatic pressure while simultaneously exposed to a liquid treatment.

### TECHNICAL FIELD

The present invention relates to a food processing apparatus, method of preserving a food product and preserved food product, and more specifically, to a specially treated and packaged food product having a substantially enhanced shelf life.

### BACKGROUND OF THE INVENTION

Food processors, and retailers of processed food products have endeavored, through the years, to develop and sell processed food products having extended shelf life for consumption by consumers. These efforts to develop food products having an extended shelf life have included, among others, preparing food products which include various additives and other ingredients which, in one fashion, or another, restrain the growth of microbial populations, or the further natural breakdown or deterioration of the food product occasioned by its processing. Various packaging techniques have also been employed, and which may include the use of various thermal treatments which have been utilized to substantially reduce or eliminate microbial populations, or to further create an environment which enhances the shelf life of the product.

While these various methods and other packaging techniques have operated with a great deal of success, various shortcomings are attendant with each of these particular prior art practices. For example, many consumers object to the addition of various additives to their food products in view of accompanying health risks associated with same. For example, some food products have included large amounts of salt as an additive. It is well known that salt has a deleterious effect on those patients suffering from high blood pressure and other cardiovascular disorders. Yet further, certain additives may cause other medical conditions to manifest themselves. An example of such an ingredient are sulfites which may be a trigger periodic and severe migraine headaches in some individuals. Still further, certain food products that are processed using various thermal processing techniques change in there overall appearance, or further, their flavors and textures are modified such that they become undesirable in certain food applications. Moreover, these same prior art techniques often render the food product less than fresh from a consumer's standpoint, thereby reducing their overall commercial appeal.

One prior art technique which has recently emerged as showing promise in the preservation of various food products includes the use of high pressure processing (HPP). This technique, which is now utilized in Europe, has the effect of substantially inactivating pathogenic microorganisms with minimal heat treatment. This technique also results in the almost complete retention of nutritional and sensory characteristics of the food product without sacrificing shelf life. This technique has also demonstrated advantages over traditional thermal processing of foods by reducing process times and minimizing heat damage problems. Still further this process has also shown a propensity to retain the freshness, flavor and color of the food being processed while not losing substantially any vitamin C. An example of an apparatus which employs the HPP process can be commercially secured under the trade name QFP35L-600 and which is manufactured by Flow International Corporation of Kent, Wash.

Accordingly, a food processing apparatus, method of preserving a food product and preserved food product which achieves the benefits to be derived from the aforementioned technology, but which avoids the determents individually associated with such prior art methods and other techniques, is the subject matter of the present invention.

### SUMMARY OF THE INVENTION

A first aspect of the present invention relates to a method of preserving a food product and which includes subjecting a food product to be preserved to ultra high hydrostatic pressure in the presence of a liquid treatment.

Another aspect of the present invention relates to a method of preserving a food product and which includes, providing a food product to be preserved; chilling the food product to a temperature; slicing the food product into a plurality of pieces; providing a liquid treatment which is useful in extending the shelf life of the food product; combining the liquid treatment with the plurality of food product pieces; separating the plurality of food product pieces from the liquid treatment; enclosing the plurality of food product pieces into a package; subjecting the package containing the plurality of food product pieces to a hydrostatic pressure of greater than about 80,000 psi for a time period; and refrigerating the resulting packaged food product pieces.

Still another aspect of the present invention relates to a food processing apparatus which includes, a conveyor assembly for moving a food product along a path of travel; a spraying assembly for dispensing a liquid and which is oriented in spraying relation relative to the conveyor assembly; a packaging station positioned downstream of the conveyor; and a hydrostatic pressure application assembly positioned downstream of the packaging station.

Yet another aspect of the present invention relates to a food processing apparatus including, a refrigeration station for chilling a food product to be processed to a temperature; a food treatment station positioned downstream of the refrigeration station, and which receives and cuts the chilled food product into a plurality of pieces; a conveyor assembly positioned downstream of the food treatment station and which transports the plurality of chilled food product pieces along a path of travel; a spraying assembly located along the path of travel, and which dispenses a source of fluid onto the chilled food product pieces which are being transported along the path of travel; a packaging station positioned downstream of the spraying station, and in receiving relation relative to the conveyor, and wherein the sprayed, chilled pieces of food product are enclosed within a package; and a hydrostatic pressure application assembly located downstream of the packaging station and which receives the package of food product pieces and which applies a hydrostatic pressure to the package for a time period.

Another aspect of the present invention relates to a preserved food product which includes a food product which has been subjected to ultra high hydrostatic pressure while simultaneously exposed to a liquid treatment.

A further aspect of the present invention relates to a packaged onion product which includes a peeled and sliced onion which has been previously exposed to a liquid treatment which includes water; calcium chloride; ascorbic acid; and calcium carbonate, and further is subjected to a hydrostatic pressure of at least about 80,000 psi.

Still another aspect of the present invention relates to a packaged onion product including a peeled and sliced onion which has been previously exposed to a liquid treatment which enhances the shelf life of the peeled and sliced onion, and has further been subjected to a hydrostatic pressure, and wherein the packaged onion product has a shelf life in excess of 30 days.

Yet another aspect of the present invention relates to a packaged onion food product which has been exposed to a hydrostatic pressure in an amount which substantially reduces the population of microorganisms which reside on, or in the packaged food product, and further is in an amount which substantially induces enzyme deactivation in the packaged onion.

These and other aspects of the present invention will become more apparent hereinafter.

### BRIEF DESCRIPTION OF THE DRAWINGS

Preferred embodiments of the invention are described below with reference to the following accompanying drawings.

FIG. 1 is a greatly simplified graphic depiction of the method and apparatus of the present invention.

### DETAILED DESCRIPTION OF THE PREFERRED EMBODIMENTS

This disclosure of the invention is submitted in furtherance of the constitutional purposes of the U.S. Patent Laws“to promote the progress of science and useful arts” (Article 1, Section 8).

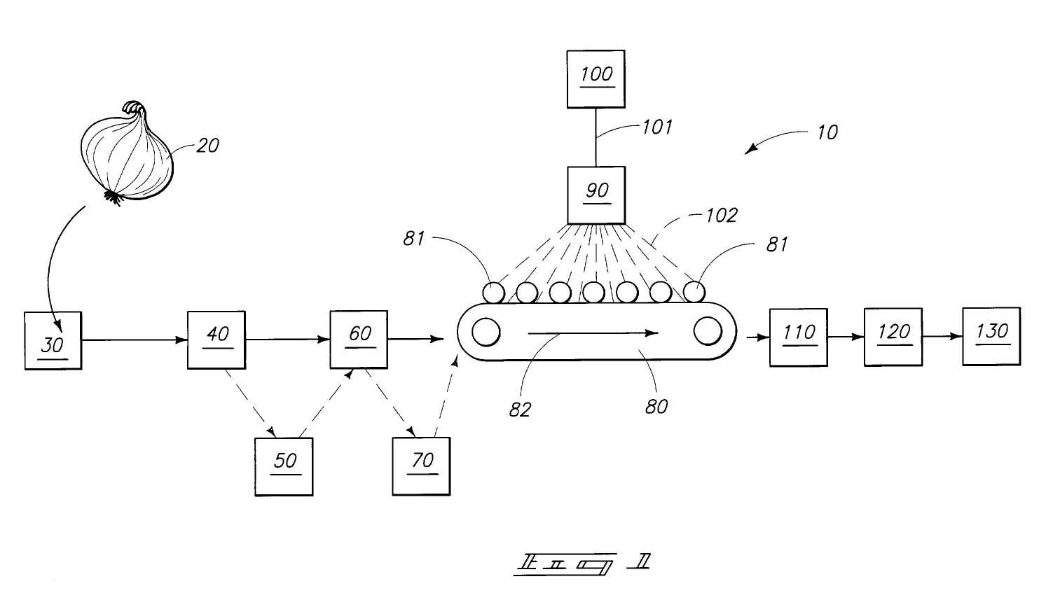

A food processing apparatus, method of preserving a food product and preserved food product of the subject invention is best understood by the greatly simplified diagram as shown in FIG. 1 and is generally indicated by the numeral 10.

As seen in FIG. 1, a source of a food product to be preserved is generally indicated by the numeral 20 and is depicted as an unprocessed, recently harvested onion. While the illustration is that of an onion, the present apparatus and method can be employed to process a variety of different food products including vegetables, meat, poultry, etc. As depicted, the source of the food product 20 is delivered by assorted means to a first refrigeration station 30. In this first refrigeration station, (assuming the food product to be processed are onions) the food product is refrigerated or otherwise chilled to a temperature of about 36° to about 40° F. Following the step of chilling the food product 20 to a reduced temperature, the food products are taken or otherwise transported to a first food processing station 40. At this first food processing station, the onion is topped, and tailed, and further the exterior peel is otherwise removed to expose the flesh beneath. The machines for accomplishing this task are well known in the art and further elaboration regarding their construction and operation is not necessary for an understanding of the present invention.

Following the step of delivering the chilled food product 20, such as an onion, to the first food processing station 40 where it has been topped, tailed and otherwise peeled, the food product 20 may be optionally delivered to a first washing station, which is generally indicated by the numeral 50. At this first washing station 50, the peeled food product, such as an onion is exposed to a water solution having a chlorine concentration of at least about fifty (50) ppm., for a time period of about one minute. Following this optional step, the food product is delivered to a second food processing station 60.

Once the food product 20 has been delivered either directly from the first food processing station 40, or alternatively from the first optional washing station 50, the second food processing station 60 is operable to slice, cut or otherwise dice the food product, such as an onion, into a plurality of pieces. Such slicing machines can be purchased from The Hobart Company as the model FP400. A further discussion regarding the slicing machines which may be utilized at the second food processing station 60 is not necessary to a further understanding of the present invention.

Once the food product 20 which is being processed at the second food processing station 60 is sliced or otherwise diced in an appropriate fashion, the sliced food product may be delivered (optionally), to a second washing station which is generally indicated by the numeral 70. At the second optional washing station 70 the food product 20 such as an onion, is exposed to a second chlorinated water solution for a period of about one minute. The chlorine content of the second chlorinated water solution is at least about fifty (50) ppm. Following the processing of the sliced food product 20 at the processing station 60, or optionally from the second washing station 70, the sliced food product 20 is delivered to a conveyor assembly generally indicated by the numeral 80. The conveyor is of conventional design and may be purchased from assorted manufacturers such as Key Technology, Inc. of Walla Walla, Wash. The conveyor is operable to transport sliced food products (now indicated by the numeral 81) along a path of travel which is generally indicated by the numeral 82.

As further illustrated in FIG. 1, it will be seen that a spraying assembly 90 is provided, and is disposed in liquid dispensing relation relative to the conveyor assembly 80. The spraying assembly 90 is coupled in fluid flow relation relative to a reservoir 100 by means of a suitable fluid conduit which is generally indicated by the numeral 101. The reservoir 100 is operable to dispense a liquid treatment 102 directly onto the plurality of food product pieces 81 which are passing along the path of travel 82. As should be understood, the liquid treatment 102 which is dispensed by the spraying assembly 90, is a liquid treatment which extends the shelf life of the food product while substantially maintaining the perceived freshness, color, and flavor of the food product. In the case of a food product such as onions, the liquid treatment can be commercially secured under the trademark“NatureSeal ONC-3 Onions” and which is commercially distributed by Mantrose-Bradshaw-Zinsser Group of Westport, Conn. As a general matter, the liquid treatment which is applied to onions includes water, calcium chloride, ascorbic acid, and calcium carbonate. Precise concentrations of these individual ingredients are maintained as proprietary by the manufacturer of this product. The manufacturer of this shelf life extension product,“NatureSeal ONC-3” for onions reports that at best, the product can extend the shelf life of fresh cut onions only for a time period of two to three weeks. The manufacturer also reports that overall, effectiveness of this product is dependent primarily on the quality, variety, and growing conditions of the product. While the present invention is discussed in terms of the above described shelf life extension product, one skilled in the art will recognize that a variety of different liquid treatments may be applied depending upon the food product being processed.

As seen in FIG. 1, and following the step of providing a liquid treatment 102 which is useful in extending the shelf life of the food product 20 to be preserved, and further after combining the liquid treatment and the food product as the food product moves along the path of travel 82, the food product 81 is removed from the liquid treatment 102 and thereafter delivered to a packaging station which is generally indicated by the numeral 110. At the packaging station, the sliced food product 81 is enclosed within an appropriate package and is thereafter covered with an oxygen permeable film and sealed within the package. Appropriate packaging may be secured from CPT/Green Tek Plastics.

As seen in FIG. 1, following the step of placing the sliced food product into appropriate packaging at the packing station 110, the packaged food product is then delivered to a hydrostatic pressure application assembly which is generally indicated by the numeral 120, and where the packaged food product is subjected to ultra high pressure in the presence of the liquid treatment previously applied by the spraying assembly 90. The ultra high pressure is applied by a hydrostatic pressure application assembly which may be commercially secured from Flow International, Inc. located in Kent, Washington. As a general matter, the amount of hydrostatic pressure which is applied is in an amount which is useful in substantially inducing enzyme deactivation in the packaged food product and/or further reducing the population of various microorganisms which may reside on or in the packaged food product. Hydrostatic pressure is applied for a time period of at least about one minute. The amount of the hydrostatic pressure is at least about 50,000 psi. In the development of a preserved food product such as packaged onions, the hydrostatic pressure which has been found useful is greater than about 80,000 psi. Once the processed food product, such as packaged sliced onions have been exposed to the hydrostatic pressure for a time period, the packaged food product is then removed from the ultra high pressure and placed in a second refrigeration station 130 where they are maintained at a reduced temperature prior to being delivered to retailers for sale.

Therefore, as will be seen from FIG. 1 the method of preserving a food product in its broadest aspect includes subjecting a food product 20 to be preserved to ultra high pressure in the presence of a liquid treatment 102. More specifically the method of preserving a food product includes providing a food product to be preserved 20; providing a liquid treatment 102 which is useful in extending the shelf life of the food product to be preserved; combining the liquid treatment 102 and the food product 20; removing the food product from the liquid treatment; and subjecting the food product to a hydrostatic pressure of greater than about 80,000 psi for a time period in the presence of the liquid treatment. As applied to such food products as onions, FIG. 1 illustrates the contemplated steps in the present method for preserving a food product which includes providing a food product to be preserved 20; chilling the food product to a temperature 30; slicing the food product into a plurality of pieces 60; providing a liquid treatment which is useful in extending the shelf life of the food product 102; combining the liquid treatment with the plurality of food pieces 81; separating the plurality of food pieces from the liquid treatment 102; enclosing the plurality of food pieces 81 into a package 110; subjecting the package containing the plurality of food product pieces to a hydrostatic pressure of greater than about 80,000 psi for a time period 120; and refrigerating the resulting packaged food product pieces 130.

A food processing apparatus for implementing the method as described above is also illustrated in FIG. 1, and includes as a general matter, a conveyor assembly 80 for moving a food product 81 along a path of travel 82. Still further the food processing apparatus includes a spraying assembly 90 for dispensing a liquid 102, and which is oriented in spraying relation relative to the conveyor assembly 80. Still further, a packaging station 110 is positioned downstream of the conveyor 80; and further a hydrostatic pressure application assembly 120 is provided and positioned downstream of the packaging station.

As illustrated in FIG. 1, the food processing apparatus as described in the paragraph immediately above includes food processing stations 40, and 60 positioned upstream of the conveyor assembly 80. Still further, a refrigeration station 30 is positioned upstream of the conveyor assembly 80, and which is operable to chill a food product 20 to be processed to a temperature. As also seen in FIG. 1, the food processing stations 40, and 60 are positioned upstream of the conveyor assembly 80 and downstream of the refrigeration station 30. As earlier disclosed, the food processing stations 40, and 60 are operable to process the food product 20 in such a manner so as to produce a plurality of product pieces 81. As seen in the drawing, a reservoir 100 is provided and coupled in fluid flowing relation with a spraying assembly 90 and which is operable to deliver a liquid treatment 102 which extends the shelf life of the food product 81. As seen in FIG. 1, the conveyor 80 transports the sliced food product 81 along a path of travel 82 where it is exposed to the treatment 102 which is dispensed from the spraying assembly 90. The hydrostatic pressure application assembly 120 is operable to provide a pressure to achieve the benefits earlier disclosed.

A food processing apparatus of the present invention therefore includes, as a general matter, a refrigeration station 30 for chilling a food product 20 to be processed to a temperature; food treatment stations 40, and 60 positioned downstream of the refrigeration station, and which receives and cuts the chilled food product into a plurality of pieces; a conveyor assembly 80 positioned downstream of the food treatment stations, and which transports the plurality of chilled food product pieces 81 along a path of travel 82; a spraying assembly 90 located along the path of travel 82, and which dispenses a source of liquid treatment 102 onto the chilled food product pieces 81 which are being transported along the path of travel; a packaging station 110 positioned downstream of the spraying station and in receiving relation relative to the conveyor, and wherein the sprayed, chilled pieces of food product are enclosed within a package; and a hydrostatic pressure application assembly 120 located downstream of the packaging station and which receives the packaged food product pieces and which applies a hydrostatic pressure to the package for a time period.

The method and apparatus of the present invention 10 provides a preserved food product which comprises a food product which has been subjected to ultra high hydrostatic pressure while simultaneously exposed to a liquid treatment. As noted above, where the food product being processed are onions, the ultra high hydrostatic pressure is at least about 50,000 psi. Still further, the liquid treatment which is applied extends the shelf life of the food product while substantially maintaining the perceived freshness, color and flavor of the food product. In the case of onions, the liquid treatment as earlier discussed comprises water; calcium chloride; ascorbic acid; and calcium carbonate. This shelf life extender can be commercially secured as disclosed earlier. As seen in FIG. 1, the packaged, peeled, and cut food products, such as onions, are refrigerated in the second refrigeration station 130 following exposure to the ultra high hydrostatic pressure applied by the hydrostatic pressure application assembly 120.

The present apparatus and method provides a convenient means for providing a packaged onion product which comprises a peeled and sliced onion which has been previously exposed to a liquid treatment which includes water; calcium chloride; ascorbic acid; and calcium carbonate, and further is subjected to a hydrostatic pressure of at least about 80,000 psi. The present method and apparatus also provides a packaged onion product which has a self life in excess of 30 days. This shelf life is more than 10 days longer than conventional prior art practices can provide. As discussed above, the hydrostatic pressure applied at station 120 is in an amount which substantially induces enzyme deactivation in the packaged onion product. Still further, the hydrostatic pressure is in an amount which substantially reduces populations of microorganisms which reside on or in the packaged onion product.

Therefore, as seen in FIG. 1, the invention 10 allows for the implementation of a method of preserving a food product 20 and wherein the food processing apparatus includes a means for moving a food product along a path of travel 80; a means for dispensing a liquid onto the food product 90 as it moves along the path of travel 80; means for enclosing the food product into a package 110 following the dispensing of the liquid 102 onto the food product 81; and means for applying hydrostatic pressure 120 to the packaged food product.

Therefore it will be seen that the invention provides a convenient apparatus, method and other means by which a food product, such as onions, may be conveniently processed, packaged and preserved and which have extended shelf life which is significantly greater than processed onions using conventional prior art processes and techniques.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

I claim:

1. A method of preserving a food product, comprising:
subjecting a food product to be preserved to ultra high hydrostatic pressure in the presence of a liquid treatment.

2. A method as claimed in claim 1, and wherein the ultra high hydrostatic pressure is greater than about 50,000 psi.

3. A method as claimed in claim 1, and wherein the liquid treatment extends the shelf-life of the food product while substantially maintaining the perceived freshness, color and flavor of the food product.

4. A method as claimed in claim 1, and wherein the liquid treatment includes water, calcium chloride, ascorbic acid; and calcium carbonate.

5. A method as claimed in claim 1, and wherein the food product to be preserved are onions, and wherein the liquid treatment includes calcium chloride, ascorbic acid, and calcium carbonate.

6. A method as claimed in claim 1, and wherein the food product to be preserved are onions, and the ultra high hydrostatic pressure is about 87,000 psi.

7. A method as claimed in claim 1, and wherein the liquid treatment includes shelf life extenders and food preservatives.

8. A method as claimed in claim 1, and wherein the food product to be preserved is a vegetable, and wherein the method further comprises:
before the step of subjecting the food product to ultra high hydrostatic pressure, pealing the vegetable to remove an outer skin;
immersing the peeled vegetable into a chlorinated water solution for a period of time;
removing the peeled vegetable from the chlorinated water solution;
after the step of removing the peeled vegetable, cutting the peeled vegetable into predetermined pieces;
immersing the cut vegetable into a second chlorinated water solution for a time period; and
removing the cut vegetable from the second chlorinated water solution.

9. A method as claimed in claim 1, and further comprising:
draining any excess liquid treatment from the food product; and
packaging the food to be preserved in appropriate packaging.

10. A method of preserving a food product, comprising:
providing a food product to be preserved;
providing a liquid treatment which is useful in extending the shelf life of the food product to be preserved;
combining the liquid treatment and the food product;
removing the food product from the liquid treatment; and
subjecting the food product to a hydrostatic pressure of greater than about 80,000 psi for a time period in the presence of the liquid treatment.

11. A method as claimed in claim 10, and wherein the food product is a vegetable and wherein after the step of providing the food product and before the step of providing the liquid treatment, the method further comprises:
peeling the vegetable to remove an outer skin; and
immersing the vegetable for a time period in a chlorinated water solution for a period of time.

12. A method as claimed in claim 11, and wherein after the step of immersing the vegetable in the chlorinated water solution, the method further comprises:
removing the peeled vegetable from the chlorinated water solution;
slicing the peeled vegetable into smaller pieces;
immersing the pieces of the peeled vegetable into a second chlorinated water solution for a period of time; and
removing the pieces of the peeled vegetable from the second chlorinated water solution.

13. A method as claimed in claim 12, and wherein the vegetable is a peeled onion, and wherein the chlorinated water solution has a chlorine concentration of at least about fifty ppm.

14. A method as claimed in claim 13, and wherein the onion is immersed in the chlorinated water solution for greater than about one minute.

15. A method as claimed in claim 14, and wherein the second chlorinated water solution has a chlorine content of at least about fifty ppm.

16. A method as claimed in claim 15, and wherein the onion is immersed in the second chlorinated water solution for greater that about one minute.

17. A method as claimed in claim 10, and wherein the food product is a peeled onion, and the liquid treatment includes water, calcium chloride, ascorbic acid, and calcium carbonate.

18. A method as claimed in claim 10, and wherein the hydrostatic pressure is about 87,000 psi.

19. A method as claimed in claim 10, and wherein the food product is a vegetable having an outer peel, and wherein the method further comprises:
peeling the vegetable to be preserved; and
slicing the vegetable into a plurality of pieces.

20. A method as claimed in claim 10, and wherein after the step of combining the liquid treatment, and before the step of subjecting the food product to the hydrostatic pressure, the method further comprises:
placing the food product on a tray and substantially sealing the food product on the tray with an oxygen permeable film.

21. A method as claimed in claim 10, and wherein after the step of subjecting the food product to a hydrostatic pressure, the method further comprises:
refrigerating the food product at a temperature of less than about 40 degrees F.

22. A method as claimed in claim 10, and wherein the step of combining the liquid treatment and the food product further comprises:
transporting the food product along a path of travel between a food preparation station, and a packaging station; and
spraying the food product with the liquid treatment as it moves along the path of travel between the food preparation station and the packaging station.

23. A method as claimed in claim 10, and wherein the food product to be preserved are onions, and wherein the step of providing the food product to be preserved further comprises:
chilling the onions to a temperature of less than about 40 degrees.

24. A method as claimed in claim 10, and wherein the food product is subject to the hydrostatic pressure for at least about 1 minute.

25. A method as claimed in claim 10, and wherein the food products are onions which are subjected to the hydrostatic pressured for at least about 2 minutes.

26. A method of preserving a food product, comprising:
providing a food product to be preserved;
chilling the food product to a temperature;
slicing the food product into a plurality of pieces;
providing a liquid treatment which is useful in extending the shelf-life of the food product;
combining the liquid treatment with the plurality of food product pieces;
separating the plurality of food product pieces from the liquid treatment;
enclosing the plurality of food product pieces into a package;
subjecting the package containing the plurality of food product pieces to a hydrostatic pressure of greater than about 80,000 psi for a time period; and
refrigerating the resulting packaged food product pieces.

27. A method as claimed in claim 26, and wherein the food products are vegetables having a peel, and wherein after the step of chilling the food product, and before the step of slicing the food product, the method further comprises peeling the food product.

28. A method as claimed in claim 27, and wherein the liquid treatment is a solution comprising water, calcium chloride, ascorbic acid, and calcium carbonate.

29. A method as claimed in claim 28, and wherein the package containing the pieces of the food product are subjected to the hydrostatic pressure for at least about 2 minutes.

30. A food processing apparatus, comprising:
a conveyor assembly for moving a food product along a path of travel;
a spraying assembly for dispensing a liquid and which is oriented in spraying relation relative to the conveyor assembly;
a packaging station positioned downstream of the conveyor; and
a hydrostatic pressure application assembly positioned downstream of the packaging station.

31. A food processing apparatus as claimed in claim 30, and further comprising:
a food processing station positioned upstream of the conveyor assembly.

32. A food processing apparatus as claimed in claim 30, and further comprising:
a refrigeration station positioned upstream of the conveyor assembly and which is operable to chill a food product to be processed to a temperature; and
a food processing station positioned upstream of the conveyor assembly and downstream of the refrigeration station, and wherein the food processing station cuts the food product to be processed into a plurality of pieces.

33. A food processing apparatus as claimed in claim 30, and wherein the liquid which is dispensed from the spraying assembly is a solution which extends the shelf life of a food product.

34. A food processing apparatus as claimed in claim 33, and wherein solution comprises water; calcium chloride; ascorbic acid; and calcium carbonate.

35. A food processing apparatus as claimed in claim 30, and wherein a food product to be preserved is transported along the path of travel by the conveyor assembly, and wherein the spraying assembly dispenses the liquid to the food product moving along the path of travel.

36. A food processing apparatus as claimed in claim 35, and wherein the food product which has been sprayed with the liquid is enclosed within packaging at the packaging station.

37. A food processing apparatus as claimed in claim 36, and wherein the packaging enclosing the sprayed food product is subjected to hydrostatic pressure for a time period by the hydrostatic pressure application assembly.

38. A food processing apparatus as claimed in claim 30, and wherein the hydrostatic pressure application assembly applies a hydrostatic pressure of at least about 80,000 psi.

39. A food processing apparatus as claimed in claim 38, and wherein the hydrostatic pressure is applied for at least about 1 minute.

40. A food processing apparatus, comprising
a refrigeration station for chilling a food product to be processed to a temperature;
a food treatment station positioned downstream of the refrigeration station, and which receives and cuts the chilled food product into a plurality of pieces;
a conveyor assembly positioned downstream of the food treatment station, and which transports the plurality of chilled food product pieces along a path of travel;
a spraying assembly located along the path of travel, and which dispenses a source of fluid onto the chilled food product pieces which are being transported along the path of travel;
a packaging station positioned downstream of the spraying station and in receiving relation relative to the conveyor, and wherein the sprayed, chilled pieces of food product are enclosed within a package; and
a hydrostatic pressure application assembly located downstream of the packaging station and which receives the package of food product pieces and which applies a hydrostatic pressure to the package for a time period.

41. An apparatus as claimed in claim 40, and wherein the food product to be processed are onions, and wherein the food processing station peels and cuts the onions into a plurality of pieces.

42. An apparatus as claimed in claim 40, and wherein the source of fluid dispensed onto the chilled food product extends the shelf life of the food product while substantially maintaining the perceived freshness, color and flavor of the food product.

43. An apparatus as claimed in claim 40, and wherein the packaged food product is subjected to a hydrostatic pressure of at least about 80,000 psi for a time period of at least about 1 min.

44. A preserved food product, comprising:
a food product which has been subjected to ultra high hydrostatic pressure while simultaneously exposed to a liquid treatment.

45. A preserved food product as claimed in claim 44, and wherein the food product are onions, and the ultra high hydrostatic pressure is at least about 50,000 psi.

46. A preserved food product as claimed in claim 44, and wherein the food product are onions, and the liquid treatment extends the shelf life of the food product while substantially maintaining the perceived freshness, color and flavor of the food product.

47. A preserved food product as claimed in claim 44, and wherein the food product are onions, and wherein the liquid treatment comprises water; calcium chloride; ascorbic acid; and calcium carbonate.

48. A preserved food product as claimed in claim 44, and wherein the food product are onions, and wherein the ultra high hydrostatic pressure is greater than about 80,000 psi.

49. A preserved food product as claimed in claim 44, and wherein the food product are onions which have been peeled and cut into a plurality of pieces prior to being subjected to the ultra high hydrostatic pressure, and exposure to the liquid treatment.

50. A preserved food product as claimed in claim 49, and wherein the peeled and cut onions are enclosed with a package following exposure to the liquid treatment and before exposure to the ultra high hydrostatic pressure.

51. A preserved food product as claimed in claim 50, and wherein the packaged, peeled, and cut onions are refrigerated following exposure to the ultra high hydrostatic pressure.

52. A packaged onion product, comprising:
a peeled and sliced onion which has been previously exposed to a liquid treatment which includes water; calcium chloride; ascorbic acid; and calcium carbonate, and further is subjected to a hydrostatic pressure of at least about 80,000 psi.

53. A packaged onion product comprising:
a peeled and sliced onion which has been previously exposed to a liquid treatment which enhances the shelf life of the peeled and sliced onion, and has further been subjected to a hydrostatic pressure, and wherein the packaged onion product has a shelf life in excess of 30 days.

54. A packaged onion product as claimed in claim 53, and wherein the hydrostatic pressure is in an amount which substantially induces enzyme deactivation in the packaged onion product.

55. A packaged onion product as claimed in claim 53, and wherein the hydrostatic pressure is in an amount which substantially reduces populations of microorganisms which reside on or in the packaged onion product.

56. A packaged onion product as claimed in claim 53, and wherein the hydrostatic pressure is applied for at least about 1 minute, and is further in an amount which substantially induces enzyme deactivation, and further substantially reduces populations of microorganisms which reside on or in the packaged onion.

57. A food processing apparatus comprising:
means for moving a food product along a path of travel;
means for dispensing a liquid onto the food product as it moves along the path of travel;
means for enclosing the food product into a package following the dispensing of the liquid on the food product; and
means for applying hydrostatic pressure to the packaged food product.

58. A food processing apparatus as claimed in claim 54, and further comprising:
means for peeling and cutting the food product into a plurality of pieces and which is located upstream of the means for moving the food product.

59. A food processing apparatus as claimed in claim 54, and wherein the food product are onions, and the means for applying hydrostatic pressure applies a pressure of at least about 80,000 psi. for a time period of at least about 1 minute.

60. A food processing apparatus as claimed in claim 56, and wherein the liquid which is dispensed is a shelf life extender.
